(19) United States
(12) Patent Application Publication
(10) Pub. No.: US 2007/0026105 A1
(43) Pub. Date: Feb. 1, 2007

(54) Method of preparing unfermented carbonated beverage comprising barley concentrate and hop extract, and unfermented carbonated beverage prepared thereby

(76) Inventors: Jang Ho Seo, Seoul (KR); Jeong Hoon Kim, Daejeon Metropolitan City (KR); Kwang Woo Yoo, Anyang-si (KR)

Correspondence Address: DICKSTEIN SHAPIRO LLP, 1825 EYE STREET NW, Washington, DC, 20006-5403, US

(21) Appl. No.: 11/213,828

(22) Filed: Aug. 30, 2005

(30) Foreign Application Priority Data
Jul. 27, 2005 (KR) 10-2005-0068249

(51) Int. Cl. C12C 7/00

(52) U.S. Cl. 426/29

(57) ABSTRACT

The present invention relates to a method of preparing an unfermented carbonated beverage including barley concentrate and hop extract and an unfermented carbonated beverage prepared using the method.

### BACKGROUND OF THE INVENTION

1. Field of the Invention

The present invention relates to a method of preparing an unfermented carbonated beverage comprising barley concentrate and hop extract, and unfermented carbonated beverages prepared thereby.

2. Description of the Related Art

In general, barley is composed mainly of starch, proteins, and β-glucan, and further includes trace components, such as water, fats, ashes, cellulose, and small amounts of vitamins. In particular, barley is a superior supply source of vitamin B groups, including large amounts of thiamine (B₁), pyridoxine (B₆), riboflavin (B₂) and pantothenic acid.

The cultivation of barley for food is estimated to have a history of 17,000-18,000 years or longer. Barley, which is used in various forms in different regions, has been used as an important staple food since the beginning of human history.

Referring to ancient Indian literature from 1,500 BC, barley was introduced due to its organoleptically astringent, cool, coarse but also light, and sweet tastes, and its physiological functions, for example, increase in the stool volume, control of body temperature, and formation of body fluids. In Korea, barley began to be cultivated from about 5-6 C BC and was the second most important grain after rice for a long time until the mid 1970s.

Barley is processed through diverse techniques for respective end uses. In this regard, considerable amounts of non-alcoholic beverages prepared using barley seeds and. malts are consumed all over the world. In some regions, barley and malt flour, obtained by roasting and grinding, are directly added to hot water and consumed as a beverage. Roasted cereal powder, barley tea, mugi-tea (Japanese barley tea), etc., are good examples of such beverages. Particularly, as for the barley tea, unhulled barley, which is main ingredient, is roasted to the extent that its hulls are carbonized, so as to be used in an unhulled whole grain state or in coarsely ground form, and thus may to be added to boiling water in a small amount and then steeped to be consumed as substitute for tea or coffee. Barley tea is a beverage used since old times in Korea, and is presently frequently enjoyed at home.

A conventional method of preparing a cooling beverage using barley is largely classified into two types, depending on the barley extract preparation processes. One method uses hulled barley, while the other method uses unhulled barley which is then malted.

In the case where the cooling beverage is prepared using a milling process, milled barley may be added with water, edible oil, an emulsifier, etc., and then heated at a high temperature of 600-750° C. for 3-5 minutes so that the added materials infiltrate into barley grains. As such, this method may be suitable in cases of coffee substitute, as oil infiltrates into the inner side and the surface of the barley and also the emulsifier is used. However, in the case of carbonated beverages diluted in a large amount of carbonated water to be mainly used in the hot season when the temperature is 30° C. or higher, oil may separate when stored for a long time, and thus, the visual quality of the product decreases. In addition, offensive odors may occur due to the oxidation of oil. Further, the added oil is heated to 600-750° C., whereby excessive peroxides may be formed which may negatively affect health. Moreover, when barley is industrially milled, material loss or nutrient loss may inevitably occur. There are also many problems to be solved in consideration of economical benefits and health.

On the other hand, in the case where the carbonated beverage is prepared using malt made from non-milled barley and a traditional process for preparing a sweet drink made from fermented rice in Korea, water-soluble components including sugar may be greatly formed by enzymes produced during germination. Hence, the above method does not negatively affect health. However, malt preparation requires a long processing time, and as well, huge malt preparation facilities are needed. Moreover, unlike in the preparation of the sweet drink, enzymes are inactivated by heating, thus negating the economic benefits of preparing a large quantity of carbonated beverage.

Presently, the beverage market is generally divided into alcoholic beverages and non-alcoholic beverages. For instance, non-alcoholic beverages are represented by carbonated beverages, and alcoholic beverages by beers.

Hops (Humulus Lupulus) are a perennial vine belonging to Moraceae and are used as a material for beer. Hops include a lupulin component, which is a complicated mixture comprising humulen, myrcene, humulon, lupulon, a hop resin, etc. Lupulin in hops functions to cause its unique flavor and bitter taste which impart a distinctive flavor and pleasant bitter taste to beer, easily form froth, and exhibit antibiotic, sedative and antiseptic effects. Further, the tannins in hops are balanced by the good taste of barley, and therefore, act to decrease a greasy feeling when taken along with greasy food.

The lupulin and tannin components of hops may be compared with the caffeine component of cola, a representative carbonated beverage in the West. The caffeine component provides a bitter taste, balancing the carbonic acid, and also, decreasing the greasy taste when taken along with greasy food. Lupulin and tannins in hops provide a bitter taste similar to caffeine, balance the carbonic acid, and decrease the greasy taste when taken along with greasy food. On the other hand, although caffeine can be addictive, lupulin in hops exhibits various physiological activities, including antibiotic, sedative and antiseptic effects, and tannin manifests enhancement in immune power, blood vessel protection and cadmium detoxification meffects.

Commonly, Barley is roasted for a long time before being extracted. In such a case, a scorched smell may be generated, and thus, it becomes difficult to mix the barley with carbonic acid. In addition, the hop extract normally reacts to form froth and when it reacts with carbonic acid gas, excessive froth may be formed and hence the process of packaging a product into a container becomes difficult.

Therefore, the development of carbonated beverages that can overcome the scorched smell problem of barley, and thus, allowing it to be easily mixed with carbonic acid is urgently required.

### SUMMARY OF THE INVENTION

Leading up to the present invention, intensive and thorough research on carbonated beverages without scorched smells, carried out by the present inventors aiming to overcome the problems encountered in the prior art, resulted in the finding that unhulled barley may be heated at a high temperature for a short time, thereby solving the scorched smell problem, and the carbonized unhulled barley may be ground, treated with enzymes, and then extracted bypassing the fermentation process, thereby increasing extraction efficiency and enriching the taste thereof, and also, a mixture comprising a barley concentrate and a hop extract may be aged at a low temperature, thereby decreasing the formation of froth due to contact between the hop extract and carbonic acid.

Accordingly, an objective of the present invention is to provide a method of preparing an unfermented carbonated beverage comprising barley concentrate and hop extract.

Another objective of the present invention is to provide an unfermented carbonated beverage prepared using the above method.

In order to accomplish the above objectives, the present invention provides a method of preparing an unfermented carbonated beverage comprising barley concentrate and hop extract.

In addition, the present invention provides an unfermented carbonated beverage prepared using the above method.

### DESCRIPTION OF THE PREFERRED EMBODIMENTS

Hereinafter, a detailed description of the present invention will be provided.

Further, in the present invention, a method of preparing an unfermented carbonated beverage comprising barley concentrate and hop extract will be provided. The detailed description of the method follows:

1) Carbonize unhulled barley at 230-260° C. for 2-5 min;

2) grind the above carbonized barley to obtain ground barley, which is then added with purified water in an amount 4-6 times the original weight of the unhulled barley and heated at 85-99° C. for a period from 30 minutes to 2 hours;

3) cool the heated barley mixture to a temperature ranging from room temperature to 60° C., adding the cooled barley mixture with 0.05 to 0.3 parts by weight of amylase and 0.02 to 0.3 parts by weight of protease based on 100 parts by weight of the unhulled barley, and then enzymolyzing the barley mixture at 40-60° C. for 3-10 hr;

4) heating the enzymolyzed barley mixture at 95° C. or higher for 5-10 min to inactivate the enzyme;

5) filtering the enzyme-inactivated barley mixture to remove residue, and then concentrating the filtered barley mixture, to obtain a barley concentrate;

6) mixing 0.01-0.1% wt. of barley concentrate obtained in step 5), 0.01-0.1% wt. of hop extract, 5-15% wt. of sugar or isomerized sugar, 0.1-0.5% wt. of citric acid, and the balance of purified water, and then stirring the mixture;

7) sterilizing the solution mixed and stirred in step 6) at 95-110° C. for 20-30 sec, and then cooling it to 3-10° C.;

8) adding a flavor to the solution cooled in step 7), and then stirring the solution;

9) aging the mixture obtained in step 8) for 10-24 hr in an aseptic state while maintaining the temperature at 5-13° C.; and

10) adding the solution aged in step 9) with 0.5-1.0 parts by weight of carbonic acid gas based on 100 parts by weight of the aged solution, to prepare an unfermented carbonated beverage.

According to the present invention, each step of the method of preparing the unfermented carbonated beverage is individually described below.

1) Carbonation of Unhulled Barley

The unhulled barley selected is carbonized at 230-260° C. for 2-5 min, thereby not generating a scorched smell.

If the unhulled barley is carbonized at a high temperature for a long time, a strong scorched smell is generated. Thus, it is preferable that the unhulled barley be briefly carbonized at a high temperature to prevent a scorched smell from being generated.

2) Grinding and Gelatinization

The carbonized barley is ground, added with purified water in an amount 4-6 times the original weight of the unhulled barley, and then heated at 85-99° C. for a period from 30 min to 2 hr, to gelatinize starch.

3) Enzymolysis

The barley mixture gelatinized in step 2) is cooled to a temperature ranging from room temperature to 60° C., added with 0.05 to 0.3 parts by weight of amylase and 0.02 to 0.3 parts by weight of protease based on 100 parts by weight of the unhulled barley, and then subjected to enzymolysis at 40-60° C. for 3-10 hr, to obtain an enzymolyzed solution.

As in steps 2) and 3), the carbonized barley is ground, treated with enzymes, and then extracted without fermentation, so that extraction efficiency is further increased and the taste becomes deep and rich.

4) Inactivation of Enzymes

The enzymolyzed solution of barley obtained in step 3) is heated at 95° C. or higher, and preferably, 95-100° C., for 5-10 minutes to inactivate the enzymes.

5) Purification and Concentration

The enzymolyzed solution of barley inactivated in step 4) is filtered to remove residue, and then concentrated in a vacuum, thus obtaining a barley concentrate. The barley concentrate preferably has a concentration of 10-20 Brix %. 6) Stirring

0.01-0.1% wt. of barley concentrate obtained in step 5), 0.01-0.1% wt. of hop extract, 5-15% wt. of sugar or isomerized sugar, 0.1-0.5% wt. of citric acid, and the remainder of purified water are mixed together and then stirred at room temperature for 10-30 minutes.

If the portion of the barley concentrate is less than 0.01% wt. of, the good taste and flavor of the barley becomes deteriorated. Meanwhile, if the portion exceeds 0.10% wt. of, a strong scorched smell may be generated.

In addition, if the portion of the hop extract is less than 0.01% wt. of, the unique pleasant bitter taste of the hops may be diluted and thus weakened. On the other hand, if the hop extract portion exceeds 0.10% wt. of, the taste is too bitter, and thus, is not well balanced with the carbonic acid.

As such, the hop extract is obtained by hydrothermal extraction by subjecting hops to a series of processes of drying in the shade, grinding, adding purified water, and heating at 95-100° C. for 10-30 minutes. Alternatively, commercially available hop extracts may be used.

7) sterilization and Cooling

The stirred mixture from step 6) is sterilized at a high temperature for a short time, preferably, at 95-110° C. for 20-30 seconds, and is then cooled down to 3-10° C.

8) Addition of Flavor

The cooled mixture from step 7) is added with 0.01-0.20% wt. of flavor relative to the total weight of the mixture, and is then stirred. The flavoring used in the present invention includes natural flavors such as vanilla, chocolate, fruit, or plants, and artificial flavors. In the present invention, a barley flavor is preferable.

9) Aging at Low temperature

The mixture obtained in step 8) is aged for 10-24 hours in an aseptic state while maintaining the temperature at 5-13° C. In this way, through the aging process at a low temperature, the formation of froth caused by contact between the hop extract and carbonic acid can be diminished.

10) Addition of Carbonic Acid

The solution aged in step 9) is added with 0.5-1.0 parts by weight of carbonic acid gas based on 100 parts by weight of the aged solution.

The unfermented carbonated beverage comprising barley concentrate and hop extract obtained through the present invention can be consumed packaged in certain containers, such as, cans, bottles or PET containers.

In the present invention, the unfermented carbonated beverage comprising barley concentrate and hop extract does not have a scorched smell because unhulled barley is heated at a high temperature for a short time. Further, the carbonized unhulled barley is ground, treated with enzymes, and then extracted without fermentation, whereby extraction efficiency is increased and a deep and rich taste is obtained. Furthermore, the barley concentrate is mixed with the hop extract and then undergoes aging at a low temperature, whereby the formation of froth, caused by contact between the hop extract and carbonic acid, is decreased. Hence, the unfermented carbonated beverage of the present invention has the rich taste of barley and the unique flavor and pleasant bitter taste of hops, thus quenching thirst and also reducing a greasy taste when taken along with greasy food. Also, from a functional point of view, digestion stimulating function of barley is provided, together with the antibiotic, sedative and antiseptic effects of hops, therefore supplying the refreshing zest to the taste.

A better understanding of the present invention may be obtained in light of the following examples which are set forth to illustrate, but are not to be construed to limit the present invention.

### EXAMPLE 1

### Preparation of Carbonated Beverage

1. Preparation of Barley Concentrate

Unhulled barley was carbonized at 250° C. for 3 minutes. The carbonized barley was ground, added with purified water in an amount 4-6 times the original weight of the unhulled barley and then heated at 90° C. for 1 hour. The heated barley mixture was cooled to room temperature, added with 0.10 parts by weight of amylase and 0.10 parts by weight of protease based on 100 parts by weight of the unhulled barley, and then enzymolyzed at 50° C. for 5 hours. Subsequently, the enzymolyzed barley mixture was heated at 95° C. or higher for 10 minutes to have the enzymes inactivated. The enzyme-inactivated barley mixture was filtered to have residue removed and then concentrated, thus obtaining a barley concentrate having a concentration of 15 Brix %.

2. Preparation of Hop Extract

Hops were dried in the shade, ground, added with purified water in an amount 4-6 times the amount of hops, and then hydrothermally extracted at 95-100° C. for 10-30 minutes, yielding the hop extract.

3. Preparation of Carbonated Beverage

0.01% wt. of barley concentrate having a concentration of 15 Brix % prepared as disclosed in 1 above; 0.02% wt. of hop extract having a concentration of 0.01 Brix % prepared as disclosed in 2 above; 12% wt. of refined sugar; 0.1% wt. of citric acid; and the remainder of purified water were mixed together. The mixture was sterilized at 100° C. for 30 sec and thereafter cooled to 7° C. The cooled mixture was added with 0.05% wt. of barley flavor, aged at a low temperature of 10° C. for 10 hours, added with 0.76 parts by weight of carbonic acid gas based on 100 parts by weight of the aged solution, and then packaged into a container.

### Comparative Example 1

A carbonated beverage was prepared in the same manner as in Example 1, with the exception that unhulled barley was carbonized at 250° C. for 15 minutes.

### Comparative Example 2

A carbonated beverage was prepared in the same manner as in Example 1, with the exception that the carbonized unhulled barley was enzymolyzed without having been ground.

### Comparative Example 3

A carbonated beverage was prepared in the same manner as in Example 1, with the exception that hop extract was not added.

### Experimental Example

Organoleptic Evaluation For organoleptic evaluation of carbonated beverages of the present invention, a consumer taste testing was conducted.

(1) Preparation of Sample

All samples were prepared at one time and stored in a refrigerator (4° C.), and the evaluation was conducted for two days. 20 ml of samples at 10° C. were put into each paper cup and water was prepared so that consumers may rinse out their mouths. The test was carried out at individual booths.

(2) Selection of Organoleptic Panels

30 males and females in their twenties were selected and tested at 11-12 a.m. and 3-5 p.m.

(3) Evaluation Items and Methods

Barley tea and hop extract were used as controls, and tastes of carbonated beverages of the present invention were evaluated.

The results are shown in Table 1 below.

TABLE 1

| | Taste and Flavor | Note |
|---|---|---|
| Ex. 1 | The good taste and flavor of | Balances well with |
| | barley and bitter taste and | carbonic acid |
| | flavor of hops balanced well | |
| | together. | |
| C. Ex. 1 | Strong scorched smell | Did not balance well |
| | | with carbonic acid |
| C. Ex. 2 | Decrease in good taste and | Slightly diluted taste |
| | flavor of barley | |
| C. Ex. 3 | No rich taste due to lack of | Lack of pleasant taste |
| | bitter taste | and refreshing zest |
| Control | Good taste and flavor | — |
| (Barley Tea) | | |
| Control | Bitter Taste | — |
| (Hop Extract) | | |

As is apparent from Table 1, the carbonated beverage of the present invention had relevantly good taste and flavor of barley, and a good balance between the bitter flavor of hops and the carbonic acid.

The carbonated beverage of Comparative Example 1 had a strong scorched smell generated by carbonating unhulled barley at a high temperature for a long time, and thus, did not balance well with the carbonic acid.

The good taste and flavor of barley in the carbonated beverage of Comparative Example 2 was deteriorated and somewhat diluted, by using the barley concentrate obtained through enzymolysis without having been ground.

The carbonated beverage of Comparative Example 3 was lacking in pleasant bitter taste by not using the hop extract, thus the refreshing zest taste decreased.

Therefore, in the unfermented carbonated beverage comprising a barley concentrate and a hop extract of the present invention, the unhulled barley is heated at a high temperature for a short time, and thus, the scorched smell is not generated. Further, the unhulled barley is ground, enzymolyzed, and then extracted without fermentation, thereby increasing extraction efficiency and enriching the taste. Moreover, the mixture comprising a barley concentrate and a hop extract is aged at a low temperature, whereby the formation of froth caused by contacting the hop extract with carbonic acid is decreased. Accordingly, it appears that the taste and flavor of barley are appropriately good and the bitter flavor of the hops is balanced by the carbonic acid.

As described hereinbefore, the present invention provides a method for preparing an unfermented carbonated beverage comprising barley concentrate and hop extract, and an unfermented carbonated beverage prepared thereby. According to the present invention, the unfermented carbonated beverage comprising barley concentrate and hop extract has no scorched smell because unhulled barley is heated at a high temperature for a short time only. In addition, the carbonized unhulled barley is ground, treated with enzymes, and then extracted without fermentation, thus increasing the extraction efficiency and enriching the taste. In addition, the barley concentrate is mixed with the hop extract and then aged at a low temperature, whereby the formation of froth caused by contact between the hop extract and the carbonic acid is decreased. Hence, the unfermented carbonated beverage of the present invention is advantageous because the barley taste is enriched and the unique flavor and pleasant bitter taste of hops are present , thus quenching the thirst and reducing the greasy taste when taken along with greasy food. Also, from a functional point of view, the digestion stimulating effects of barley and the antibiotic, sedative and antiseptic effects of hops are provided, therefore giving the refreshing zest to the beverage.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of preparing an unfermented carbonated beverage comprising barley concentrate and hop extract, the method comprising:
1) carbonizing unhulled barley at 230-260° C. for 2-5 minutes;
2) grinding the carbonized barley to obtain ground barley, which is then added with purified water in an amount 4-6 times an original weight of the unhulled barley and is then heated at 85-99° C. for a period from 30 minutes to 2 hours;
3) cooling the heated barley mixture to a temperature ranging from room temperature to 60° C., adding the cooled barley mixture with 0.05 to 0.3 parts by weight of amylase and 0.02 to 0.3 parts by weight of protease based on 100 parts by weight of the unhulled barley, and then enzymolyzing the barley mixture at 40-60° C. for 3-10 hours;
4) heating the enzymolyzed barley mixture at 95° C. or higher for 5-10 minutes to inactivate enzymes;
5) filtering the enzyme-inactivated barley mixture to remove residue, and then concentrating the filtered barley mixture to obtain barley concentrate;
6) mixing 0.01-0.1% wt. of barley concentrate, obtained in step 5), 0.01-0.1% wt. of hop extract, 5-15% wt. of sugar or isomerized sugar, 0.1-0.5% wt. of citric acid, and the remainder of purified water, and then stirring the mixture;
7) sterilizing the solution mixed and stirred in step 6) at 95-110° C. for 20-30 seconds, and then cooling the solution to 3-10° C.;
8) adding flavoring to the solution cooled in step 7), and then stirring the solution;
9) aging the mixture obtained in step 8) for 10-24 hours in an aseptic state while the temperature is maintained at 5-13° C.; and
10) adding the solution aged in step 9) with 0.5-1.0 parts by weight of carbonic acid gas based on 100 parts by weight of the aged solution, to prepare an unfermented carbonated beverage comprising barley concentrate and hop extract.

2. The method as set forth in claim 1, further comprising packaging the carbonated beverage into a container, such as, bottles or PET containers, following step 10).

3. An unfermented carbonated beverage comprising barley concentrate and hop extract prepared using the method of claim 1.
